(19) United States
(12) Patent Application Publication
(10) Pub. No.: US 2014/0254013 A1
(43) Pub. Date: Sep. 11, 2014

(54) OPTICAL MEMBER WITH DOUBLE RAINBOW FILM

(71) Applicant: Samsung Electronics Co., Ltd., Gyeonggi-do (KR)

(72) Inventor: Sil-Kyu LIM, Gyeonggi-do (KR)

(73) Assignee: Samsung Electronics Co., Ltd., Gyeonggi-do (KR)

(21) Appl. No.: 14/197,938

(22) Filed: Mar. 5, 2014

(30) Foreign Application Priority Data
Mar. 5, 2013 (KR) 10-2013-0023311

(51) Int. Cl. G02B 5/30

(52) U.S. Cl. CPC G02B 5/3083
USPC 359/489.07; 359/489.01

(57) ABSTRACT

An optical member for transmitting or reflecting light is provided. The optical member includes a base member that transmits or reflects light; and a double rainbow film attached on the base member. Preferably, the double rainbow film has an in-plane phase difference in a range of 8,000 nm to 11,000 nm. When the optical member is used together with a display device, there is little color shift before and during wearing sunglasses and a rainbow-like stain which appears in a conventional display device when wearing sunglasses with a polarizing function may be suppressed.

### PRIORITY

This application claims priority under 35 U.S.C. §119(a) to Korean Application Serial No. 10-2013-0023311, which was filed in the Korean Intellectual Property Office on Mar. 5, 2013, the entire content of which is incorporated herein by reference.

### BACKGROUND

1. Field of the Invention

The present invention generally relates to an optical member such as a window member or a polarizing plate for use in a display device, a lens for eyeglasses including sunglasses, and a contact lens, and more particularly, to an optical member for preventing distortion of a transmitted or reflected image or picture, especially colors.

2. Description of the Related Art

Typically, an optical member refers to a lens or the like that converts an image or picture to a desired path and a desired size while reflecting light, and in a more broad sense, includes an optical film, a window member or the like that is disposed on a front face of a display device.

Use of a flat panel display device in various devices such as a television, a computer monitor, a portable terminal, and a mobile communication terminal has become common and competition with respect to image quality has intensified. A flat panel display device is typically configured using display elements such as a Liquid Crystal Display (LCD), a Plasma Display Panel (PDP), and an Organic Light Emitting Diode (OLED). The LCD produces an image by driving liquid crystal which is an anisotropic material and requires optical compensation films because light provided from a backlight unit produces a considerable phase difference with respect to light passing through the LCD.

As an example of such an optical compensation film, a PolyVinyl Alcohol (PVA) film that provides a polarizing function. The PVA film is usually disposed on each of the front and rear faces of a display element such as an LCD, and a Tri-Acetyl Cellulose (TAC) film is attached to each of the front and rear faces of the PVA film so as to prevent damage to the PVA film. In addition, in order to improve endurance, an anti-scratch property, an optical characteristic, etc. of the optical compensation film, a hard coating or a low-reflective coating may be formed on the front or rear face of the PVA film, or a PolyEthylene Terephthalate (PET) film or a Cyclo Olefin Polymer (COP) film may be attached to the front or rear face of the PVA film.

Meanwhile, when a person is wearing sunglasses, in particular, sunglasses with a polarizing function during outdoor activities such as water sports or cycling, a screen implemented on a display device of, for example, a portable terminal may be viewed in a distorted state. Specifically, when the display device screen is viewed through polarized sunglasses, a screen color is distorted or a rainbow-like stain occurs on the surface of the display.

These effects are caused due to a phase difference of coating layers or films provided for improving the physical characteristics of the optical compensation film, and thus color distortion or a rainbow-like stain appears on a surface of a display device. In other words, due to the phase difference of the optical compensation film itself, lights of different wavelength bands, i.e. lights of different colors are distorted while penetrating the optical compensation film. This distortion phenomenon is predominant when wearing sunglasses with a polarizing function.

### SUMMARY

The present invention has been made to address at least the problems and disadvantages described above, and to provide at least the advantage described below.

Accordingly, an aspect of the present invention is to provide an optical member capable of suppressing distortion of a screen output from a display element.

Another aspect of the present invention is to provide an optical member capable of preventing the occurrence of a rainbow-like stain or color distortion on a screen output from a display element even if the screen is seen through sunglasses with a polarizing function.

According to an aspect of the present invention, an optical member transmitting or reflecting light is provided. The optical member includes a base member that transmits or reflects light, and a double rainbow film attached on the base member.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram illustrating an optical member according to an embodiment of the present invention in which a polarizing film is configured as a base member;

FIG. 2 is a diagram illustrating a modified example of the optical member illustrated in FIG. 1;

FIG. 3 is a diagram illustrating an optical member according to another embodiment of the present disclosure in which a window member is configured as a base member; and

FIGS. 4 to 7 are diagrams illustrating modified examples of the optical member illustrated in FIG. 3, respectively.

### DETAILED DESCRIPTION OF EMBODIMENTS OF THE PRESENT INVENTION

The following description with reference to the accompanying drawings is provided to assist in a comprehensive understanding of various embodiments of the present invention as defined by the claims and their equivalents. It includes various specific details to assist in that understanding but these are to be regarded as mere examples. Accordingly, those of ordinary skill in the art will recognize that various changes and modifications of the various embodiments described herein can be made without departing from the scope and spirit of the present invention. In addition, descriptions of well-known functions and constructions may be omitted for clarity and conciseness.

The terms and words used in the following description and claims are not limited to their dictionary meanings, but are merely used to enable a clear and consistent understanding of the present invention. Accordingly, it should be apparent to those skilled in the art that the following description of various embodiments of the present invention is provided for illustration purposes only and not for the purpose of limiting the present invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An optical member according to the present invention includes a base member that transmits or reflects light and a Double Rainbow Film (DRF) attached to the base member. The base member may usually be configured by a polarizing film or a window member disposed on a front face of a display device. However, a lens for eyeglasses such as sunglasses, a contact lens, or a vehicle window may also be used as the base member. That is, the optical member may be configured using a polarizing plate, a window member, various lenses, a window, an optical mirror, etc. which have been already commercially available as a base member. However, in the following descriptions of specific embodiments, it shall be noted that a polarizing plate or a window member may be described as the optical member applied to the display device.

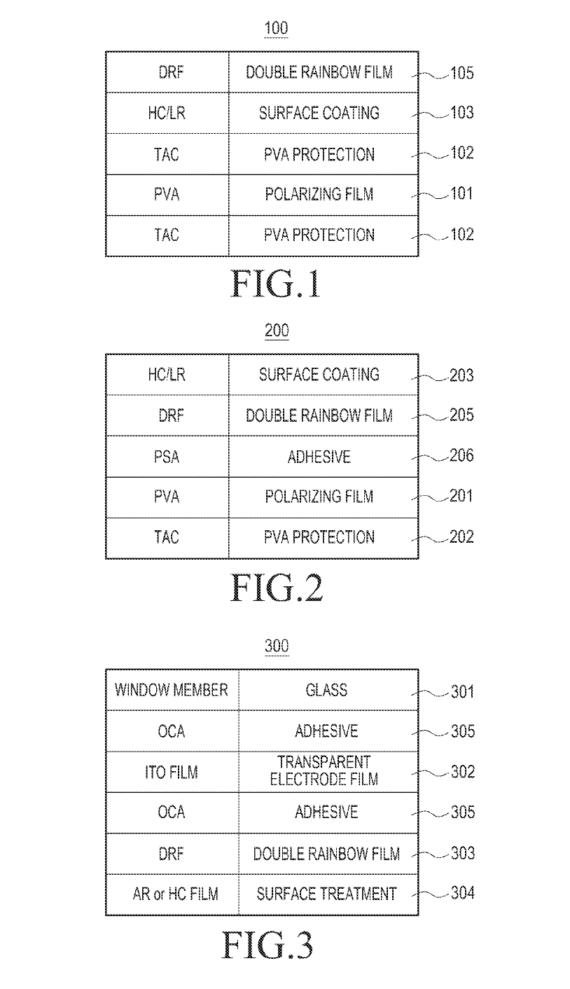

FIGS. 1 and 2 illustrate polarizing plates for a display device, and FIGS. 3 to 7 illustrate window members for a display device.

FIGS. 1 and 2 illustrate optical members 100 and 200, respectively, in which a PVA film 101 or 201 that provides a polarizing function is provided as a base member and a double rainbow film 105 or 205 is attached to the PVA film 101 or 201. In FIG. 1, TAC films 102 may be respectively attached to both surfaces of the PVA film 101 as a protective film that provides a protection function, and a surface coating layer 103 such as a hard coating or a low-reflective coating may be formed on a surface of each of the TAC films 102. When it is desired to attach the optical member 100 to another window member or a display element, an adhesive layer may be formed on one surface of the optical member 100. In FIG. 2, a TAC film 202 is disposed on only one surface of the PVA film 201 and the double rainbow film 205 is disposed on the other surface so that, on the other surface of the PVA film 201, the double rainbow film 205 replaces the protection function of the TAC film. At this time, an adhesive layer 206 is formed between the PVA film 201 and the double rainbow film 205. The adhesive layer 206 formed between the double rainbow film 205 and the PVA film 201 may be made of a Pressure Sensitive Adhesive (PSA). Although FIG. 1 illustrates the configuration in which the double rainbow film 105 is disposed outside the surface coating layer 103, the surface coating layer 203 may be disposed outside the double rainbow film 205, as illustrated in FIG. 2.

The surface coating layer 103 or 203 is made of a Hard Coating (HC) layer so that the surface coating layer 103 or 203 may contribute to the improvement of an anti-scratch property or the like on the optical member 100 or 200. In addition, the surface coating layer 103 or 203 may be made of one of an Anti-Reflective (AR) coating layer, a Low-Reflective (LR) layer, and an Anti-Glare (AG) coating layer. The anti-reflective coating layer, the low-reflective coating layer or the anti-glare coating layer generally contribute to the improvement of the optical characteristics of the optical member 100 or 200.

In general, phase difference films manufactured to have an in-plane phase difference in a range of 500 nm to 1000 nm are commercially available. However, the double rainbow films 105 and 205 are manufactured to have an in-plane phase difference in a range of 8000 nm to 11000 nm. Here, the “in-plane phase difference (Re)” is defined as “Re=(nx−ny)×D” in which nx indicates a refractive index in a direction of an axis where a maximum refractive index is represented in a plane (slow axis), ny means a refractive index in a direction orthogonal to the slow axis, and D means a thickness of a film. The double rainbow film may be made of any one of a Cyclo-Olefin Polymer (COP) film, a Cyclo-Olefin Co-polymer (COC) film, a PolyCarbonate (PC) film, a PolyEthylene Terephthalate (PET) film, a PolyPropylene (PP) film, a PolySulFone (PSF) film, and a PolyMethylMethAcrylate (PMMA) film.

A display device to which the optical member as described above, specifically the polarizing plate, is applied may suppress distortion of the color of the output screen of the display device or appearance of a rainbow-like stain even when wearing sunglasses with a polarizing function. In particular, in a conventional display device, a color shift Δu′v′ before and after wearing the sunglasses with a polarizing function was measured as 0.064 whereas in a display device equipped with the optical member according to the present invention, the color shift Δu′v′ was measured as 0.0007. That is, the optical member that employs the double rainbow film together with the PVA film is substantially free of a color shift before and after wearing the sunglasses with a polarizing function.

FIGS. 3 to 7 illustrate optical members 300, 400, 500, 600 and 700 applied to a display device, respectively, in which a window member 301, 401, 501, 601 or 701 disposed on the front face of a display element that implements a practical screen is used as a base member. Each of the optical members illustrated in FIGS. 3 to 7 uses a window member made of a synthetic resin or a glass material as a base member, and includes a double rainbow film 303, 403, 503, 603 or 703 attached to the window member. As in the previous embodiments, the double rainbow film is fabricated to have an in-plane phase difference in the range of 8000 nm to 11000 nm. At this time, each of the optical members, except for optical member 600, includes at least one Indium-Tin Oxide film (ITO) film 302, 402, 502 or 702 attached to one face of the window member to be capable of providing a touch screen function. The ITO film is combined with a display device as a transparent electrode film for a touch screen which is used for detecting a user's touch position, thereby providing the touch screen function.

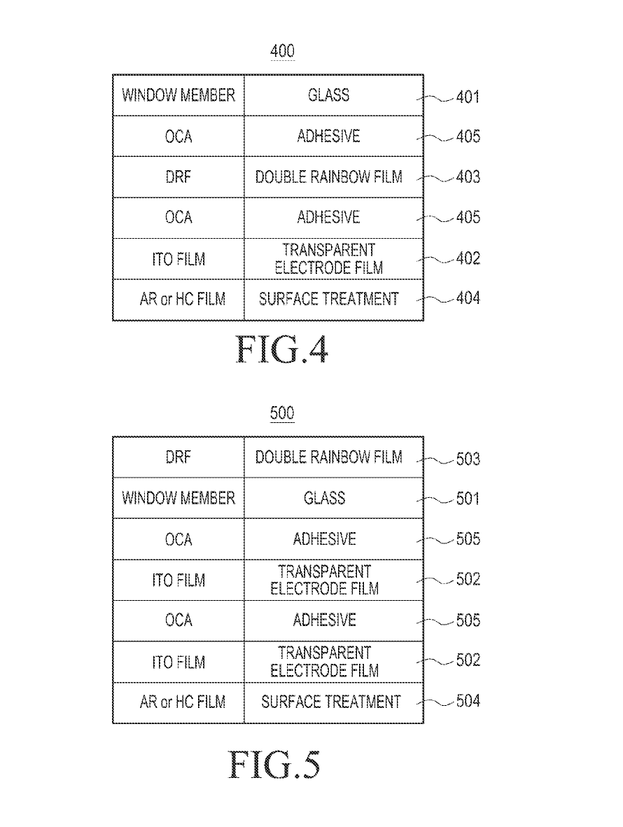

Each of FIGS. 3 and 4 illustrates an example of a configuration in which one ITO film 302 or 402 and the double rainbow film 303 or 403 are attached to the window member 301 or 401. The double rainbow film 303 or 403 is laminated on one surface of the window member 301 or 401 together with the ITO film 302 or 402 in which the double rainbow film 303 or 403 may be disposed to face the window member 301 with the ITO film 302 being interposed therebetween, or interposed between the window member 401 and the ITO film 402. An Optical Clear Adhesive (OCA) layer 305 or 405 is preferably formed either between the window member 301 or 401 and the double rainbow film 303 or 403 or between the double rainbow film 303 or 403 and the ITO film 302 or 402. When the double rainbow film 303 or 403 or the ITO film 302 or 402 is positioned on a surface of the optical member 300 or 400, a surface coating layer 304 or 404 may be formed in order to prevent damage by an external environment. As in the previous embodiments, the surface coating layer 304 or 404 may be made of any one of a hard coating layer, an anti-reflective coating layer, a low-reflective coating layer, and an anti-glare coating layer or may be configured by attaching a film which may perform the same function as the surface coating layer 304 or 404. Even in a case where the window member 301 or 401 is made of a synthetic resin, the surface hardness and optical characteristics may be strengthened by forming the surface coating layer as described above on the surface of the window member 301 or 401.

FIG. 5 illustrates an example of a configuration in which the double rainbow film 503 is disposed on the other surface of the window member 501 and a plurality of ITO films 502 are laminated on the one surface of the window member 501. In the optical member 500 illustrated in FIG. 5, an OCA layer 505 may be interposed either between the window member 501 and one ITO film 502 or between the ITO films 502, and another OCA layer (not shown) may be further interposed between the window member 501 and the double rainbow film 503. Moreover a surface coating layer or film 504 may be provided to protect the double rainbow film 503 or the ITO film 502 from the external environment.

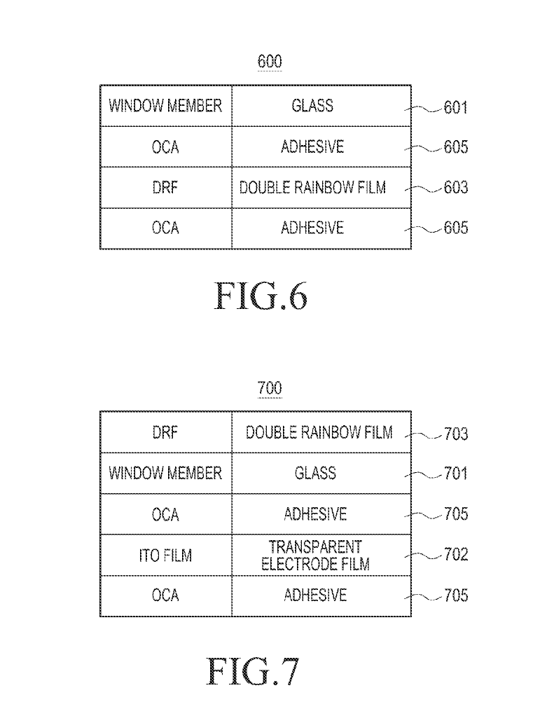

FIG. 6 illustrates a modified example of the optical member 400 in which a simple window member 601 which is not equipped with a touch screen function is used as a base member. On the inner surface of the window member 601, a double rainbow film 603 is attached and in particular, an OCA layer 605 is formed between the window member 601 and the double rainbow film 603 so as to attach the double rainbow film 603 to the window member 601.

FIG. 7 illustrates a modified example of the optical member 500 illustrated in FIG. 5 in which only one ITO film 702 is attached to one surface of the window member 701. On the other surface of the window member 701, a double rainbow film 703 is attached, and an OCA layer 705 is interposed between the window member 701 and one surface of the ITO film 702 and formed on the other surface of the ITO film 702.

The display device equipped with an optical member that uses a window member of a synthetic resin material or a glass material as a base member as described above and to which a double rainbow film is attached is substantially free of a color shift before and during wearing sunglasses with a polarizing function. Further, even when wearing sunglasses with a polarizing function, it is possible to see a clear screen which is free of a rainbow-like stain on the screen of the display device equipped with the optical member.

It has been found that, when an optical member configured as described above is used together with a display device, there is little color shift before and after wearing sunglasses with a polarizing function. Specifically, in a conventional display device, a color shift Δu′v′ before and after wearing sunglasses polarizing function was measured as 0.064, but in a display device equipped with the optical member according to the present invention, the color shift Δu′v′ was measured as 0.0007 and did not show a rainbow-like stain. Further, when the optical member is an optical compensation film, a double rainbow film may be used instead of a TAC film that protects a PVA film. In this case, the manufacturing cost of the optical compensation film may be reduced by 20% to 30%. In addition, even in a case where a window member made of a synthetic resin or a glass material and a double rainbow film are combined, the occurrence of color distortion or a rainbow-like stain while wearing sunglasses with a polarizing function may be suppressed. In addition, since the double rainbow film is used as a substrate film of an ITO film provided on the window member so as to provide a touch screen function, a physical property of the optical member may be improved without increasing the thickness of the display device. Of course, when the double rainbow film is used instead of the substrate film of the ITO film, it is possible to exclude the manufacturing cost of the ITO film. Moreover, when the double rainbow film is attached to a base member that transmits light, e.g., eyeglasses, a contact lens, or a vehicle window, or a base member that reflects light, e.g., an optical mirror, it is possible to prevent a color shift and an optical illusion showing a stain which occur when wearing sunglasses with a polarizing function.

Although optical members in which a polarizing plate or a polarizing film used in a display device is used as a base member have been described in the specific embodiments as examples, the optical members according to the present invention may also use a lens for eyeglasses such as sunglasses, a contact lens, or a vehicle window as a base member.

In the foregoing, although several embodiments have been described, it is obvious to a person ordinarily skilled in the art that various modifications may be made without departing from the scope of the present invention.

What is claimed is:

1. An optical member for transmitting or reflecting light, the optical member comprising:
a base member that transmits or reflects light; and
a double rainbow film attached to the base member.

2. The optical member of claim 1, wherein the base member is a window member made of a synthetic resin or a glass material, and a polarizing film.

3. The optical member of claim 1, further comprising a protective film attached to at least one surface of the base member,
wherein the base member is a polarizing film made of a polyvinyl alcohol and the protective film is a triacetylcellulose film.

4. The optical member of claim 1, further comprising a protective film attached at least one surface of the base member,
wherein the base member is a polarizing film made of polyvinyl alcohol, and the protective film is made of triacetylcellulose and interposed between the base member and the double rainbow film.

5. The optical member of claim 1, further comprising a surface coating layer formed on at least one surface of the base member,
wherein the base member is a polarizing film made of polyvinyl alcohol, and the double rainbow film is laminated on one surface of the base member together with the surface coating layer.

6. The optical member of claim 5, wherein the surface coating layer is one of a hard coating layer, an anti-reflective coating layer, a low-reflective coating layer, and an anti-glare coating layer.

7. The optical member of claim 1, wherein the base member is a window member made of a synthetic resin or a glass material, and the double rainbow film is attached to one surface of the window member.

8. The optical member of claim 1, further comprising at least one Indium-Tin Oxide (ITO) film attached to one surface of the base member, and the base member is a window member made of a synthetic resin or a glass material.

9. The optical member of claim 8, wherein the double rainbow film is attached to the other surface of the base member or between the base member and the ITO film.

10. The optical member of claim 8, further comprising a surface coating layer formed on the base member,
wherein the surface coating layer is one of a hard coating layer, an anti-reflective coating layer, a low-reflective coating layer, and an anti-glare coating layer.

11. The optical member of claim 10, wherein at least one of the double rainbow film and the ITO film is disposed between the base member and the surface coating layer.

12. The optical member of claim 1, wherein the double rainbow film has an in-plane phase difference in a range of 8,000 nm to 11,000 nm.

13. The optical member of claim 12, wherein the double rainbow film is one of a Cyclo-Olefin Polymer (COP) film, a Cyclo-Olefin Co-polymer (COC) film, a PolyCarbonate (PC) film, a PolyEthylene Terephthalate (PET) film, a Poly-Propylene (PP) film, a PolySulFone (PSF) film, and an PolyMethylMethAcrylate (PMMA) film.
